(19) United States
(12) Patent Application Publication
(10) Pub. No.: US 2005/0021334 A1
(43) Pub. Date: Jan. 27, 2005

(54) Information-processing apparatus, information-processing method and information-processing program

(76) Inventor: Naoto Iwahashi, Kanagawa (JP)

Correspondence Address: JAY H. MAIOLI;Cooper & Dunham LLP, 1185 Avenue of the Americas, New York, NY, 10036, US

(21) Appl. No.: 10/860,747

(22) Filed: Jun. 3, 2004

(30) Foreign Application Priority Data
Jun. 11, 2003 (JP) P2003-167109

(51) Int. Cl. G10L 15/12

(52) U.S. Cl. 704/240

(57) ABSTRACT

An information-processing apparatus, a method thereof, and a program therefor that can give an utterance adaptively to changes of the condition of a person and changes in environment. The information-processing apparatus for giving an utterance to a conversational partner to make the conversational partner understand an intended meaning of the utterance, includes a function inference element for inferring an overall confidence level function representing a probability that the conversational partner correctly understands the utterance, and an utterance generation element for giving the utterance by estimating a probability that the conversational partner correctly understands the utterance on the basis of the overall confidence level function.

### BACKGROUND OF THE INVENTION

The present invention relates to an information-processing apparatus, an information-processing method and an information-processing program. More particularly, the present invention relates to an information-processing apparatus allowing an intention to be communicated between a-person and a system interacting with the person with a higher degree of accuracy, relates to an information-processing method adopted by the apparatus as well as relates to an information-processing program for implementing the method.

Traditionally, a system interacting with a person is implemented on typically a robot. The system requires a function to recognize an utterance given by a person and a function to give an utterance to a person.

Conventional techniques for giving an utterance include a slot method, a ‘different way of saying’ method, a syntactical transformation method and a generation method based on a case structure.

The slot method is a method of giving utterance by applying words extracted from an utterance given by a person to words of a sentence structure. An example of the sentence structure is ‘A gives C to B’ and, in this case, the words of this typical sentence structure are A, B and C. The ‘different way of saying’ method is a method of recognizing words included in an original utterance given by a person and giving another utterance by saying results of the recognition in a different way. For example, a person gives an original utterance saying: “He is studying enthusiastically”. In this case, the other utterance given as a result of the recognition of the utterance states: “He is learning hard”.

The syntactical transformation method is a method of recognizing an original utterance given by a person and giving another utterance by changing the order of words included in the original utterance. For example, an original utterance says: “He puts a doll on a table”. In this case, another utterance for the original utterance states: “What he puts on a table is a doll”. The generation method based on a case structure is a method of recognizing the case structure of an original utterance given by a person and giving another utterance by adding proper particles to words in accordance with a commonly known word order. An example of the original utterance says: “On the New-Year day, I gave many New Year's presents to children of relatives”. In this case, another utterance for the original utterance states: “Children of relatives received many New Year's presents from me on the New-Year day”.

It is to be noted that the conventional methods for giving an utterance are described in documents including Chapter 9 of ‘Natural Language Processing’ authored by Makoto Nagao, a publication published by Iwanami Shoten on Apr. 26, 1996. This reference is referred to hereafter as non-patent document 1.

In order for a system to implement smooth communication with a person, it is desirable to give proper utterances from the system adaptively to changes of the condition of the person and changes in environment such as a situation in which the person understands the utterances. With the conventional methods for giving utterances as described above, however, a fixed utterance scheme is given to the system designer in advance, raising a problem that utterances cannot be given adaptively to the changes of the condition of the person and the changes in environment.

### SUMMARY OF THE INVENTION

It is thus an object of the present invention addressing the problem to provide a capability of giving an utterance adaptively to changes of the condition of the person and changes in environment.

An information-processing apparatus provided by the present invention is characterized in that the apparatus includes function inference means for inferring an overall confidence level function representing the probability that a conversational partner correctly understands an utterance by a learning process and utterance generation means for giving an utterance by estimating a probability that the conversational partner correctly understands the utterance on the basis of the overall confidence level function.

The utterance generation means is capable of giving an utterance also on the basis of a determination function for inputting an utterance and an understandable meaning of the utterance and for representing the degree of propriety between the utterance and the understandable meaning of the utterance.

The overall confidence level function is capable of inputting a difference between a maximum value of an output generated by the determination function as a result of inputting an utterance used as a candidate to be generated as well as an intended meaning of the input utterance and a maximum value of an output generated by the determination function as a result of inputting the utterance used as a candidate to be generated as well as a meaning other than the intended meaning of the input utterance.

An information-processing method provided by the present invention is characterized in that the method includes the step of inferring an overall confidence level function representing the probability that a conversational partner correctly understands an utterance by a learning process and the step of giving an utterance by estimating a probability that the conversational partner correctly understands the utterance on the basis of the overall confidence level function.

An information-processing program provided by the present invention as a program to be executed by a computer is characterized in that the program includes the step of inferring an overall confidence level function representing the probability that a conversational partner correctly understands an utterance by a learning process and the step of giving an utterance by estimating a probability that a conversational partner correctly understands the utterance on the basis of the overall confidence level function.

In the information-processing apparatus, the information-processing method and the information-processing program, which are provided by the present invention, an utterance is generated on the basis of the overall confidence level function representing the probability that a conversational partner correctly understands the utterance.

As described above, in accordance with the present invention, it is possible to implement an apparatus capable of interacting with a person.

In addition, in accordance with the present invention, an utterance can be given adaptively to the changes of the condition of the person and the changes in environment.

### BRIEF DESCRIPTION OF THE DRAWINGS

FIG. 1 is an explanatory diagram showing a communication between a robot and a conversational partner;

FIG. 2 shows a flowchart referred to in explaining an outline of a process carried out by a robot to acquire a language;

FIG. 3 is an explanatory block diagram showing a typical configuration of a word-and-act determination apparatus applying the present invention;

FIG. 4 is a bock diagram showing a typical configuration of a generated-utterance determination unit employed in the word-and-act determination apparatus shown in FIG. 3;

FIG. 5 shows a flowchart referred to in explaining a process of learning an overall confidence level function;

FIG. 6 is an explanatory diagram showing a process of learning an overall confidence level function;

FIG. 7 is an explanatory diagram showing a process of learning an overall confidence level function; and

FIG. 8 is a block diagram showing a typical configuration of a personal computer applying the present invention.

### DETAILED DESCRIPTION OF THE PREFERRED EMBODIMENTS

An embodiment of the present invention will be described below. Prior to the description, however, relations associating configuration elements described in claims with concrete examples revealed in the embodiment of the present invention are explained as follows. In the following description, the concrete examples revealed in the embodiment of the present invention support and verify inventions described in the claims. The description of the embodiment may include a concrete example, which is not explicitly explained as an example corresponding to a configuration element described in the claims. However, the fact that a concrete example is not explicitly explained as an example corresponding to a configuration element does not necessarily mean that such a concrete example does not correspond to the configuration element. Conversely, even though the description of the embodiment may include a concrete example, which is explicitly explained as an example corresponding to a specific configuration element described in the claims, the fact that a concrete example is explicitly explained as an example corresponding to the specific configuration element does not necessarily mean that such a concrete example does not correspond to an configuration element other than the specific configuration element.

In addition, inventions confirmed and supported by described concrete examples of the embodiment of the present invention are not all described in the claims. In other words, the existence of inventions confirmed and supported by described concrete examples of the embodiment of the present invention but not described in the claims does not deny the existence of inventions that can be separately claimed or added as amendments in the future.

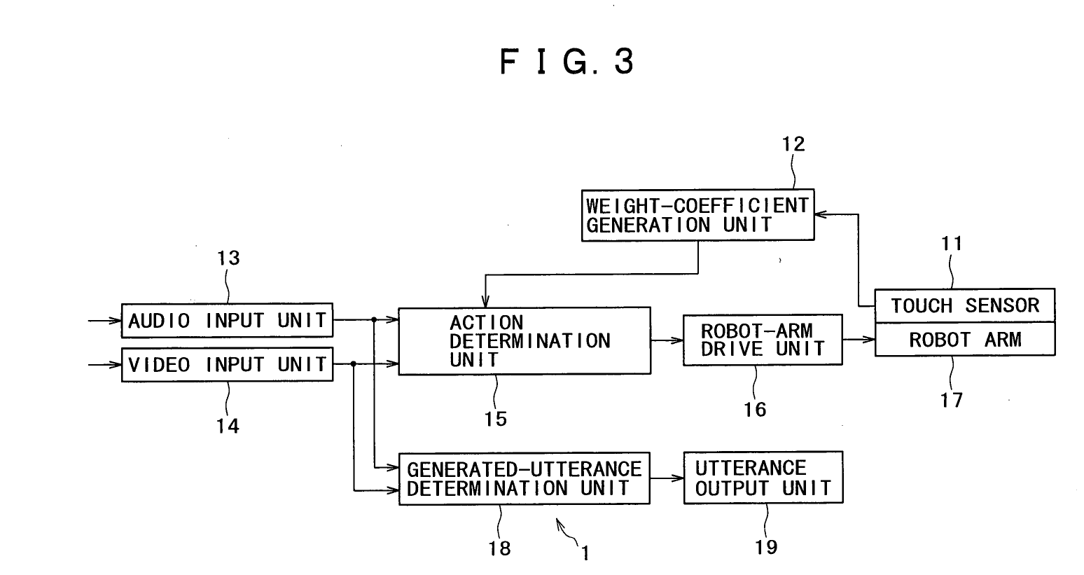

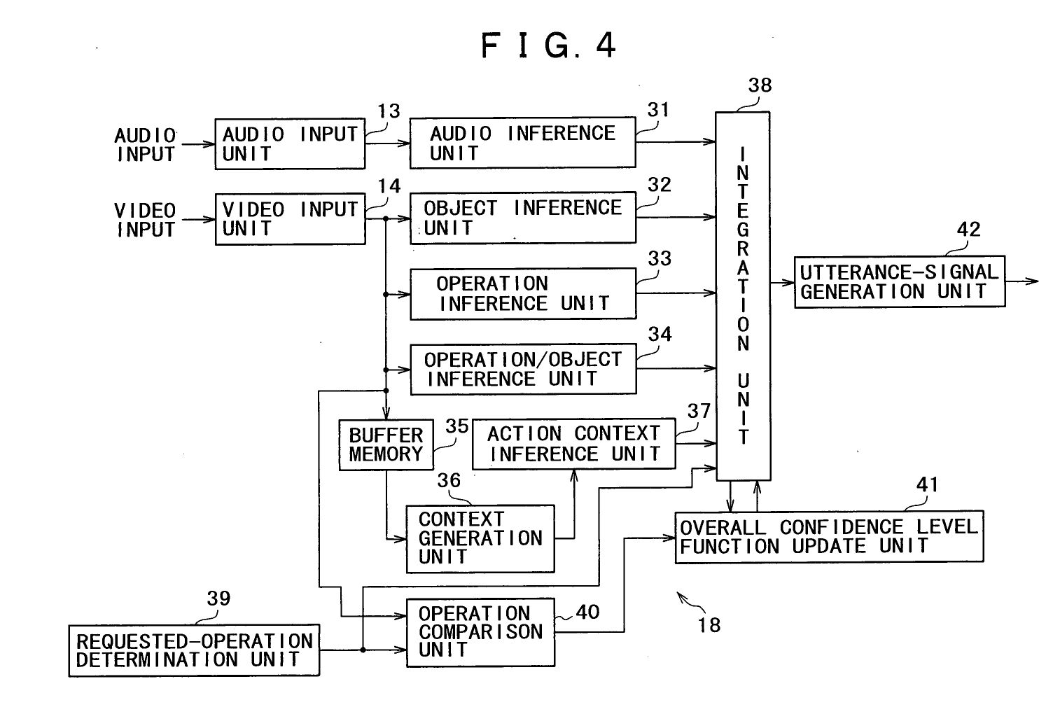

That is to say, the information-processing apparatus (such as a word-and-act determination apparatus 1 shown in FIG. 3) provided by the present invention is characterized in that the apparatus includes function inference means (such as an integration unit 38 shown in FIG. 4) for inferring an overall confidence level function representing the probability that a conversational partner correctly understands an utterance and utterance generation means (such as an utterance-signal generation unit 42) for generating an utterance by estimating a probability that a conversational partner correctly understands the utterance on the basis of the overall confidence level function.

It is to be noted that relations associating configuration elements described in claims as configuration elements of an information-processing method with concrete examples revealed in the embodiment of the present invention are the same as the relations associating configuration elements described in claims as configuration elements of the information-processing apparatus with concrete examples revealed in the embodiment. In addition, relations associating configuration elements described in claims as configuration elements of an information-processing program with concrete examples revealed in the embodiment of the present invention are also the same as the relations associating configuration elements described in claims as configuration elements of the information-processing apparatus with concrete examples revealed in the embodiment. Thus, it is not necessary to repeat the description.

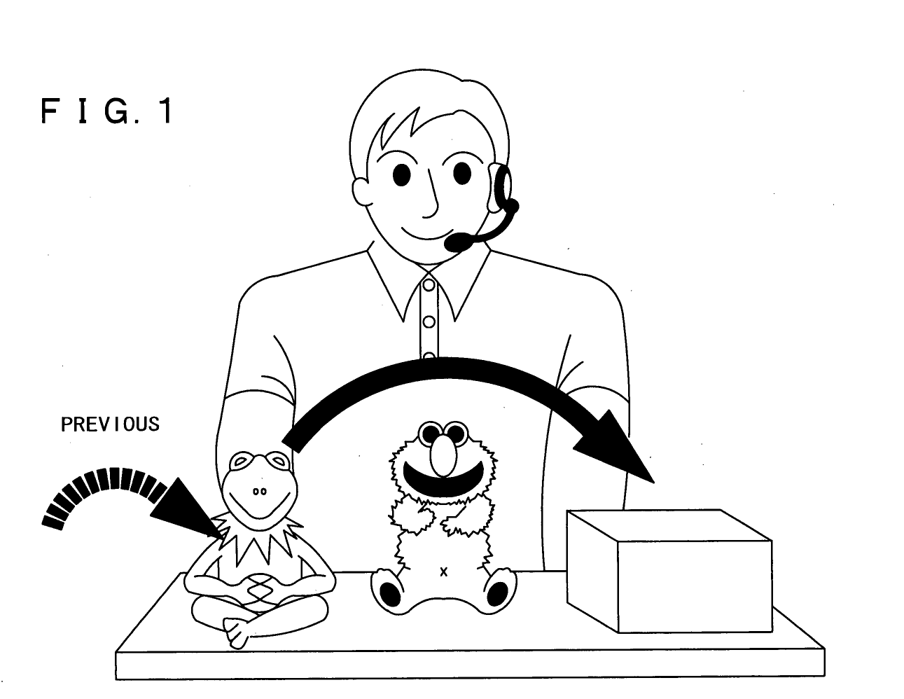

An outline of the word-and-act determination apparatus applying the present invention is explained as follows. The word-and-act determination apparatus carries out a communication using objects with a partner of a conversation, learns a gradually increasing number of words and actions by receiving audio and video signals representing utterances given by the partner of a conversation respectively, carries out predetermined operations according to utterances given by the partner of a conversation on the basis of a result of learning and gives the partner of a conversation utterances each requesting the partner of a conversation to carry out an operation. In the following description, the partner of a conversation is referred to simply as a conversational partner. Examples of the objects mentioned above are a doll and a box, which are prepared on a table as shown in FIG. 1. An example of the communication carried out by the word-and-act determination apparatus with the conversational partner is the conversational partner giving an utterance stating: “Mount Kermit (a trademark) on a box”, and an act of-placing the doll on the right end on the box on the left end.

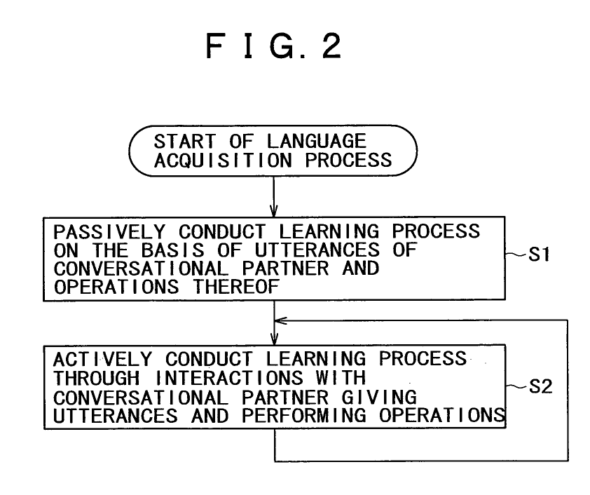

In an initial state, the word-and-act determination apparatus has neither a concept of objects and a concept of how to move the objects nor a language faith including words corresponding to acts and the grammar of the words. The language faith is developed step by step as depicted by a flowchart shown in FIG. 2. To be more specific, at a step S1, the word-and-act determination apparatus conducts a learning process passively on the basis of utterances given by the conversational partner and operations carried out by the partner. Then, at the next step S2, the word-and-act determination apparatus conducts a learning process actively through interactions with the conversational partner giving utterances and carrying out operations.

An interaction cited above involves an act done by one of two parties to give an utterance making a request for an operation to the other party, an act done by the other party to understand the given utterance and carry out the requested operation and an act done by one of the two parties to evaluate the operation carried out by the other party. The two parties are the conversational partner and the word-and-act determination apparatus.

FIG. 3 is a diagram showing a typical configuration of the word-and-act determination apparatus applying the present invention. In the case of this typical configuration, the word-and-act determination apparatus 1 is incorporated in a robot.

A touch sensor 11 is installed at a predetermined position on a robot arm 17. When a conversational partner swats the robot arm 17 with a hand, the touch sensor 11 detects the swatting and outputs a detection signal indicating that the robot arm 17 has been swatted to a weight-coefficient generation unit 12. On the basis of the detection signal output by the touch sensor 11, the weight-coefficient generation unit 12 generates a predetermined weight coefficient and supplies the coefficient to the action determination unit 15.

An audio input unit 13 is typically a microphone for receiving an audio signal representing contents of an utterance given by the conversational partner. The audio input unit 13 supplies the audio signal to the action determination unit 15 and a generated-utterance determination unit 18. A video input unit 14 is typically a video camera for taking the image of an environment surrounding the robot and generating a video signal representing the image. The video input unit 14 supplies the video signal to the action determination unit 15 and the generated-utterance determination unit 18.

The action determination unit 15 applies the audio signal received from the audio input unit 13, information on an object included in the image represented by the video signal received from the video input unit 14 and a weight coefficient received from the weight-coefficient generation unit 12 to a determination function for determining an action. In addition, the action determination unit 15 also generates a control signal for the determined action and outputs the control signal to a robot-arm drive unit 16. The robot-arm drive unit 16 drives the robot arm 17 on the basis of the control signal received from the action determination unit 15.

The generated-utterance determination unit 18 applies the audio signal received from the audio input unit 13 and information on an object included in the image represented by the video signal received from the video input unit 14 to the determination function and an overall confidence level function to determine an utterance. In addition, the generated-utterance determination unit 18 also generates a control signal for the determined utterance and outputs the control signal to an utterance output unit 19.

The utterance output unit 19 outputs a sound of the determined utterance or displays a string of characters representing the determined utterance to make the conversational partner understand an utterance signal received from the generated-utterance determination unit 18 as the control signal for the determined utterance.

FIG. 4 is a diagram showing a typical configuration of the generated-utterance determination unit 18. An audio inference unit 31 carries out an inference process based on contents of an utterance given by the conversational partner in accordance with an audio signal received from the audio input unit 13. The audio inference unit 31 then outputs a signal based on a result of the inference process to an integration unit 38.

An object inference unit 32 carries out an inference process on the basis of an object included in a video signal received from the video input unit 14 and outputs a signal obtained as a result of the inference process to the integration unit 38.

An operation inference unit 33 detects an operation from a video signal received from the video input unit 14, carries out an inference process on the basis of the detected operation and outputs a signal obtained as a result of the inference process to the integration unit 38.

An operation/object inference unit 34 detects an operation and an object from a video signal received from the video input unit 14, carries out an inference process on the basis of a relation between the detected operation and the detected object and outputs a signal obtained as a result of the inference process to the integration unit 38.

A buffer memory 35 is used for storing a video signal received from the video input unit 14. A context generation unit 36 generates an operational context including a time context relation on the basis of video data including past portions stored in the buffer memory 35 and supplies the operational context to an action context inference unit 37.

The action context inference unit 37 carries out an inference process on the basis of the operational context received from the context generation unit 36 and outputs a signal representing a result of the inference process to the integration unit 38.

The integration unit 38 multiplies a result of an inference process carried out by each of the units ranging from the audio inference unit 31 to the action context inference unit 37 by a predetermined weight coefficient and applies every product obtained as a result of the multiplication to the determination function and the overall confidence level function to give an utterance to the conversational partner as a command requesting the partner to carry out an operation corresponding to a signal received from a requested-operation determination unit 39. The determination function and the overall confidence level function will be described later in detail. In addition, the integration unit 38 also outputs a signal for the generated utterance to the utterance-signal generation unit 42.

The requested-operation determination unit 39 determines an operation that the conversational partner is requested to carry out and outputs a signal for the generated operation to the integration unit 38 and an operation comparison unit 40.

The operation comparison unit 40 detects an operation carried out by the conversational partner from a signal received from the video input unit 14 and determines whether or not the detected operation matches an operation for the signal received from the requested-operation determination unit 39. That is to say, the operation comparison unit 40 determines whether or not the conversational partner has correctly understood the operation determined by the requested-operation determination unit 39 and is carrying out the operation accordingly. In addition, the operation comparison unit 40 supplied the result of the determination to an overall confidence level function update unit 41.

The overall confidence level function update unit 41 updates the overall confidence level function generated by the integration unit 38 on the basis of the determination result received from the operation comparison unit 40.

The utterance-signal generation unit 42 generates an utterance signal on the basis of a signal received from the integration unit 38 and outputs the generated utterance signal to the utterance output unit 19.

Next, an outline of the operations is described.

The requested-operation determination unit 39 determines an action to be taken by the conversational partner and outputs a signal indicating the determined action to the integration unit 38 and the operation comparison unit 40. The operation comparison unit 40 detects an operation carried out by the conversational partner from a signal received from the video input unit 14 and determines whether or not the detected operation matches the operation indicated by the signal received from the requested-operation determination unit 39. That is to say, the operation comparison unit 40 determines whether or not the conversational partner is carrying out an operation after accurately understanding the operation determined by the requested-operation determination unit 39. Then, the operation comparison unit 40 outputs a result of the determination to the overall confidence level function update unit 41.

The overall confidence level function update unit 41 updates the overall confidence level function generated by the integration unit 38 on the basis of the determination result received from the operation comparison unit 40.

The utterance-signal generation unit 42 generates an utterance signal on the basis of a signal received from the integration unit 38 and outputs the generated utterance signal to the utterance output unit 19.

The utterance output unit 19 outputs a sound corresponding to the utterance signal received from the utterance-signal generation unit 42.

The conversational partner interprets contents of the utterance and carries out an operation according to the contents. The video input unit 14 takes a picture of the operation carried out by the conversational partner and outputs the picture to the object inference unit 32, the operation inference unit 33, the operation/object inference unit 34, the buffer memory 35 and the operation comparison unit 40.

The operation comparison unit 40 detects the operation carried out by the conversational partner from a signal received from the video input unit 14 and determines whether or not the detected operation matches an operation corresponding to a signal received from the requested-operation determination unit 39. That is to say, the operation comparison unit 40 determines whether or not the conversational partner is carrying out an operation after accurately understanding the operation determined by the requested-operation determination unit 39. Then, the operation comparison unit 40 outputs a result of the determination to the overall confidence level function update unit 41.

The overall confidence level function update unit 41 updates the overall confidence level function generated by the integration unit 38 on the basis of the determination result received from the operation comparison unit 40.

The integration unit 38 generates an utterance as a command given to the conversational partner on the basis of a determination function based on inference results received from the units ranging from the audio inference unit 31 to the action context inference unit 37 and on the basis of the updated overall confidence level function, outputting a signal representing the generated utterance to the utterance-signal generation unit 42.

The utterance-signal generation unit 42 generates an utterance signal on the basis of a signal received from the integration unit 38 and supplies the utterance signal to the utterance output unit 19.

As described above, the generated-utterance determination unit 18 conducts a learning process of properly giving an utterance in accordance with the understanding of the conversational partner to comprehend the utterance given by the robot.

Next, the word-and-act determination apparatus 1 incorporated in the robot is explained in detail as follows.

[Algorithm Overview]

In a process conducted by the robot to master a language, four mutual faiths, namely, a phoneme vocabulary, a relation concept, a grammar and word usages, are learned separately in accordance with four algorithms respectively.

In a process to learn the four mutual faiths, namely, the phoneme vocabulary, the relation concept, the grammar and the word usages, a joint sense experience is gained by demonstrative operations carried out by the conversational partner to move an object and show the moving object to the robot. The joint sense experience serves as a base. In addition, inference of an integration probability density of audio information and video information, which are associated with each other, is used as a basic principle.

In the process to learn the mutual faith of the word usages, joint acts done by the robot and the conversational partner mutually in accordance with the utterances given by the conversational partner serve as a base, and maximization of the probability that the robot correctly understands utterances given by the conversational partner as well as maximization of the probability that the conversational partner correctly understands utterances given by the robot are used as a basic principle.

It is to be noted that the algorithms assume that the conversational partner behaves cooperatively. In addition, since the pursuit of the basic principle of each algorithm is set as an objective, each of the mutual faiths is very simple. Consideration is given to keep as much consistency of a learning reference as possible through all the algorithms. However, the four algorithms are evaluated separately and they are not integrated as a whole.

[Learning of Mutual Faiths]

If a vocabulary L and a grammar G are learned, the robot is capable of understanding utterances to a certain degree by taking maximization of an integration probability density function p(s, a, O; L, G) as a reference. In order to make the robot capable of understanding and giving utterances more dependent on the current situation, however, the robot is taught to learn more and more the word-usage mutual faith through communications with the conversational partner in an online way.

Examples of the understanding and the generation of utterances by using the mutual faiths are described as follows. As shown in FIG. 1, for example, as an immediately preceding operation, the conversational partner places the doll on the left side and then gives a command to the robot to place the doll on the box. In this case, the conversational partner may give the robot an utterance saying: “Place the doll on the box”. If the conversational partner assumes that the robot embraces a faith that an object moved at an immediately previous time is most likely taken as a next movement object, however, it is quite within the bounds of possibility that the conversational partner gives a simpler utterance stating: “Place, on the box” by omitting the words ‘the doll’ used as the operation object. If the conversational partner further assumes that the robot embraces a faith that the box is likely used as a thing on which an object is to be mounted, it is quite within the bounds of possibility that the conversational partner gives an even simpler utterance stating: “Place, thereon”.

In order for the robot to understand such simpler utterances, the robot must be assumed to embrace the assumed faiths, which are shared by the conversational partner. This assumption applies to a case in which the robot gives an utterance.

[Expression of Mutual Faiths]

In an algorithm, a mutual faith is expressed by a determination function Ψ representing the degree of properness associating an utterance with an operation and an overall confidence level function f representing the confidence level of the robot for the determination function Ψ.

The determination function Ψ is represented by a set of weighted faiths. The weight of a faith indicates the confidence level of the robot for the sharing of the faith by the robot and the conversational partner.

The overall confidence level function f outputs an estimated value of the probability that the conversational partner correctly understands an utterance given by the robot.

[Determination Function Ψ]

An algorithm can be used for handling a variety of faiths. The following description takes a faith regarding sounds, objects and movements and two non-lingual faiths as examples. The faith regarding sounds, objects and movements is expressed by a vocabulary and a grammar.

[Vocabulary]

In the vocabulary learning, the conversational partner utters a word while placing an object on a table and pointing to the object whereas the robot associates the sound of the word with the object. By carrying out these operations repeatedly, a characteristic quantity s of the sound and a characteristic quantity o of the object are obtained. A set data of pairs each including the characteristic quantity s of the sound and the characteristic quantity o of the object is referred to as learning data.

The vocabulary L is expressed by a set of pairs p(s |ci) and p(o |ci) where i =1, - - - and M. Each pair includes the probability density function of a sound for a vocabulary item and the probability density function of an object image for the sound. The probability density function is abbreviated hereafter to a pdf. Notation M is the number of vocabulary items and notations c₁, c₂, - - - and c_{M} each denote an index representing a vocabulary item.

Learning parameters representing the vocabulary-article count M and all the pdfs p(s |ci) and p(o |ci), where I =1, - - - and M, is the objective. This learning process raises a problem characterized in that the learning process is conducted to find a set of pairs of class membership functions in two contiguous characteristic quantity spaces without a teacher under a condition of an unknown number of pairs.

The learning process is conducted as follows. Even if an array of phonemes of a word is determined for each vocabulary item, the sound varies from utterance to utterance. Normally, however, the variations from utterance to utterance are not reflected as a characteristic of an object indicated by the utterance so that Eq. (1) given below can be used as an expression equation.
p(s, o |cᵢ) =p(s |cᵢ) p(o |cᵢ) . . . (1)

Thus, as a whole, a junction pdf of a sound and an object image can be expressed by Eq. (2) as follows:

$$p ( s , o ) = {\sum }_{i = 1}^{M} p ( s \vert {c}_{i} ) p ( o \vert {c}_{i} ) p ( {c}_{i} ) \qquad ( 2 )$$

Accordingly, the above problem is treated as a statistical learning problem of inferring values of probability distribution parameters by selecting a model optimum for p(s, o) expressed by Eq. (2).

It is to be noted that, on the basis of a concept believing that “it is desirable to have a vocabulary serving as accurate information-propagation means and having as a small number of vocabulary items as possible”, if the vocabulary-item count M is selected by taking the mutual information amount of a sound and the image of an object as a reference, a good result can be obtained from an experiment to learn approximately ten-odd words meaning the color, shape, size and name of the object.

By expressing a word pdf through a junction of a hidden Markov model (HMM) expressing a phoneme pdf, a set of phoneme pdfs can be learned at the same time, and the locus of a moved object can be used as an image characteristic quantity.

[Learning of the Relation Concept]

The context of a language can be considered to be a relation between a thing and two or more things. In the above description of a vocabulary, the concept of a thing is represented by a conditional pdf of an object image of a given vocabulary item. A relation concept to be described below involves participation of a most outstanding thing referred to hereafter as a trajector and a thing working as a reference of the trajector. The thing working as a reference of the trajector is referred to hereafter as a land mark.

When a left doll is moved as shown in FIG. 1, for example, the moved doll is a trajector. If the doll at the center is regarded as a land mark, the movement of the left doll is interpreted as ‘flying over’ but, if the box at the right end is regarded as a land mark, the movement is interpreted as ‘getting on’. A set of such scenes is used as learning data and the concept of how to move an object is learned as a process in which the relation between the positions of a trajector and a land mark changes.

Given the vocabulary item c, the position o_{t,p} of a trajector object t and the position o_{l,p} of a land-mark object, the movement concept is expressed by a conditional pdf p(u |o_{t,p}, o_{l,p}, C) of a movement locus u.

An algorithm in this case is an algorithm to learn a hidden Markov model representing the conditional pdf of the movement concept while inferring unobserved information indicating which object in a scene serves as a land mark. At the same time, the algorithm also selects a coordinate system for properly prescribing the movement locus. In the case of a ‘getting on’ locus, for example, the algorithm selects a coordinate system taking the land mark as the origin and axes in the vertical and horizontal directions as coordinate axes. In the case of a ‘departing’ locus, on the other hand, the algorithm selects a coordinate system taking the land mark as the origin and a line connecting the trajector to the land mark as one of its two axes.

[Grammar]

Grammar is rules of arranging words included in an utterance as words for expressing a relation between external sounds represented by the words. In the learning and using of the grammar, the relation concept described above plays an important role. In a process of teaching the grammar to the robot, while moving an object, the conversational partner gives an utterance representing the movement of the object. By repeating these operations, it is possible to obtain learning data to let the robot learn the grammar using the data. A set (s, a, O) is used as the learning data. In the set, notation O denotes scene information prior to the movement, notation s denotes a sound and notation a denotes the action, where a=(t, u).

The scene information O is a set of positions of all objects in a scene and image characteristic quantities thereof. A unique index is assigned to each object in every scene and notation t denotes an index assigned to the trajector object. Notation u denotes the locus of the trajector.

The scene information O and the action a are used for inferring a context z. The context z is expressed by associating words included in an utterance with configuration elements, which are the trajector, the land mark and the locus. For example, the utterance explaining the typical case shown FIG. 1 says: “Mount big Kermit (a trademark) on a brown box”. In this case, the grammar is expressed by associating words included in the utterance with configuration elements as follows:
Trajector: big Kermit
Land mark: brown box
Locus: mount
   [78

The grammar G is expressed by an occurrence probability distribution of an occurrence order of these configuration elements in an utterance. The grammar G is learned so as to maximize the likelihood of a junction pdf p(s, a, O; L, G) of the sound s, the action a and the scene O. A logarithmic junction pdf log p(s, a, O; L, G) is expressed by Eq. (3) using the vocabulary L and the grammar G as parameters as follows:

$$\begin{matrix}Log p ( s , a , O ; L , G ) \approx {max}_{z} ( ( log p ( s \vert z , O ; L , G ) + & \\ log p ( a \vert z , O ; L ) + log p ( z , O ) ) & \\ \approx α + {max}_{z , l} ( log p ( s \vert z , O ; L , G ) + & [ sound ] \\ log p ( u \vert {o}_{t , p} , {o}_{1 , p} , {W}_{M} ; L ) + & [ movement ] \\ log p ( {o}_{t , f} \vert {W}_{T} ; L ) + & [ object ] \\ log p ( {o}_{1 , f} \vert {W}_{L} ; L ) ) & \end{matrix} \qquad ( 3 )$$

In the above equation, notations W_{M}, W_{T} and W_{L} denote a word (a column) for respectively the locus, trajector and land mark in the context z whereas notation α denotes a normalization term.

[Action Context Effect B₁(i, q; H)]

An action context effect B₁(i, q; H) represents a faith believing that, under an action context q, an object i becomes the object of a command expressed by an utterance. The action context q is represented by data such as information on whether or not each object has participated in an immediately preceding action as a trajector or a land mark or information on whether or not a caution has been directed in a direction by an action taken by the conversational partner to point at the direction. This faith is represented by two parameters H={h_{c}, h_{g}}. This faith outputs the value of a corresponding one of the parameters, which is determined in accordance with the action context q, or O.

[Action Object Relation B2(o_{t,f}, o_{l,f}, W_{M}; R)]

An action object relation B2(o_{t,f}, o_{l,f}, W_{M}; R) represents a faith believing that the characteristic quantities o_{t,f} and o_{l,f} of objects are typical characteristics of respectively the trajector and the land mark in the movement concept W_{M}. The action object relation B2 (o_{t,f}, o_{i,f}, W_{M}; R) is represented by a conditional pdf joint p(o_{t,f}, o_{l,f} |W_{M}; R). This joint pdf is expressed by a Gauss distribution and notation R represents a parameter set.

[Determination Function Ψ]

As shown in Eq. (4) given below, a determination function Ψ is expressed as a sum of weighted outputs of the faith models described above.

$$\begin{matrix}Ψ ( s , a , O , q , L , G , R , H , Γ ) = {max}_{1 , z} ( {r}_{1} log p ( s \vert z ; L , G ) + & [ sound ] \\ {γ}_{2} log p ( u \vert {o}_{t , p} , {O}_{1 , p} , {W}_{M} ; L ) + & [ movement ] \\ {γ}_{2} ( log p ( {o}_{t , f} \vert {W}_{T} ; L ) + log p ( {O}_{1 , f} \vert {W}_{L} ; L ) ) + & [ object ] \\ {γ}_{3} log p ( {O}_{t , f} , {O}_{1 , f} , \vert {W}_{M} ; R ) + & [ movement \text{-} object relation ] \\ {γ}_{4} ( {B}_{1} ( t , q ; H ) + {B}_{1} ( l , q ; H ) ) ) & [ action context ]\end{matrix} \qquad ( 4 )$$

In the above equation, {γ₁, γ₂, γ₃, γ₄} is a set of weight parameters of the outputs of the faith models. An action a taken by the robot in response to an utterance s given by the conversational partner is determined in such a way that the value of the determination function Ψ is maximized.

[Overall Confidence Level Function f]

First of all, Eq. (5) given below defines a margin d of the value of the determination function Ψ used for determining the generation of an utterance s representing an action a under a scene O and an action context q.

$$\begin{matrix}d ( s , a , O , q , L , G , R , H , Γ ) = {min}_{A \neq a} ( Ψ ( s , a , O , q , L , G , R , H , Γ ) - \\ Ψ ( s , A , O , q , L , G , R , H , Γ )\end{matrix} \qquad ( 5 )$$

It is to be noted that, in Eq. (5), notation a denotes an action taken by the robot and notation A denotes an action taken by the conversational partner understanding an utterance given by the robot.

As shown in Eq. (6) given below, an overall confidence level function f outputs a probability that an utterance is correctly understood with the margin d given as an input to the function.

$$f ( d ) = \frac{1}{π} arctan ( \frac{d - {λ}_{1}}{{λ}_{2}} ) + 0.5 \qquad ( 6 )$$

In the above equation, notations λ₁ and λ₂ denote parameters representing the overall confidence level f. As is obvious from Eq. (6), the probability that the conversational partner correctly understands an utterance given by the robot is known to increase for a large margin d. A hypothetical high probability that the conversational partner correctly understands an utterance given by the robot even for a small margin d means that a mutual faith assumed by the robot well matches a mutual faith assumed by the conversational partner.

In order to request the conversational partner to take an action a in a scene 0 under an action context q, the robot gives an utterance s⁻ so as to minimize a difference between the output of the overall confidence level function f and an expected correct understanding rate ξ of typically about 0.75 as shown by Eq. (7) as follows:

$$\tilde{S} = arg {min}_{s} ( f ( d ( s , a , O , q , L , G , R , H , Γ ) ) - ξ ) \qquad ( 7 )$$

If the probability that the conversational partner correctly understands an utterance given by the robot is low, the robot is capable of giving an utterance including more words in order to increase the probability that the conversational partner correctly understands the utterance. If the probability that the conversational partner correctly understands an utterance given by the robot is predicted to be sufficiently high, on the other hand, the robot is capable of giving an utterance including fewer words by omitting some words.

[Algorithm of Learning the Overall Confidence Level Function f]

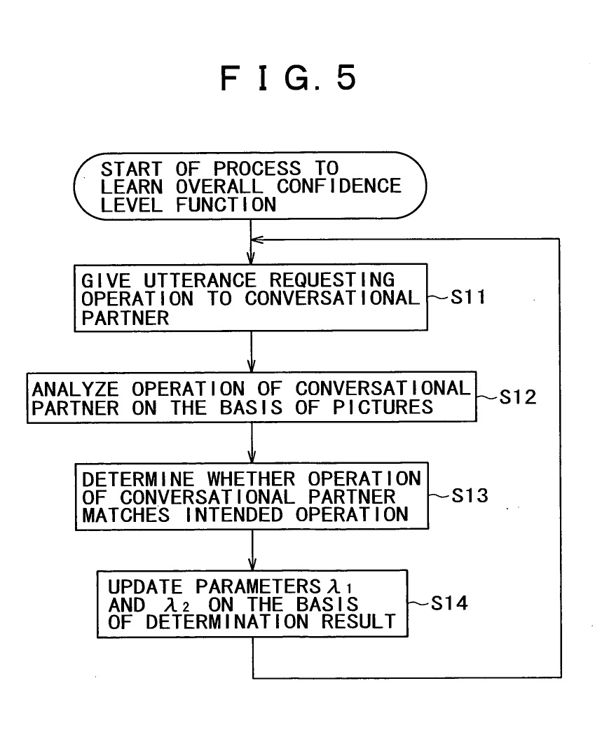

The overall confidence level function f is learned more and more in an online way by repeating a process represented by a flowchart shown in FIG. 5.

The flowchart begins with a step S11 at which, in order to request the conversational partner to take an intended action, the robot gives an utterance s⁻ so as to minimize a difference between the output of the overall confidence level function f and an expected correct understanding rate ξ. In response to the utterance, the conversational partner takes an action according to the utterance. Then, at the next step S12, the robot analyzes the action taken by the conversational partner from a received video signal. Subsequently, at the next step S13, the robot determines whether or not the action taken by the conversational partner matches the intended action requested by the utterance. Then, at the next step S14, the robot updates the parameters λ₁ and λ₂ representing the overall confidence level f on the basis of a margin d obtained in the generation of the utterance. Subsequently, the flow of the learning process goes back to the step S11 to repeat the processing from this step.

It is to be noted that, in the processing carried out at the step S11, the robot is capable of increasing the probability that the conversational partner correctly understands an utterance given by the robot by giving an utterance including more words. If understanding afforded by the conversational partner correctly understands an utterance given by the robot to a certain degree at a predetermined probability is considered to be sufficient, the robot needs to merely give an utterance including as fewest words as possible. In this case, the significant thing is not reduction of the number of words included in an utterance but, rather, promotion of a mutual faith by understanding afforded by the conversational partner correctly understands an utterance omitting some words.

In addition, in the processing carried out at the step S14, information indicating whether or not the utterance has been correctly understood by the conversational partner is associated with margin d obtained in the generation of the utterance and used as learning data. The parameters λ₁ and λ₂ existing at the completion of the ith episode (that is, the process carried out at the steps S11 to S14 ) are updated in accordance with Eq. (8) as follows:

$$[ {λ}_{1 , i} , {λ}_{2 , i} ] ← ( 1 - δ ) [ {λ}_{1 , i - 1} , {λ}_{2 , i - 1} ] + δ [ {\tilde{λ}}_{1 , i} , {\tilde{λ}}_{2 , i} ] \\ \text{In this case, the following equation holds true:} \\ [ {\tilde{λ}}_{1 , i} , {\tilde{λ}}_{2 , i} ] = {arg min}_{{λ}_{1} , {λ}_{2}} {\sum }_{j = i = K}^{i} {{ω}_{i - j} ( f ( {d}_{j} ; {λ}_{1} , {λ}_{2} ) - {e}_{j} )}^{2} \qquad ( 8 )$$

where notation eᵢ denotes a variable, which has a value of 1 if the conversational partner correctly understands the utterance or a value of 0 if the conversational partner does not correctly understand the utterance. Notation δ denotes a value used for determining a learning speed.
[95
[Verification of the Overall Confidence Level Function f]

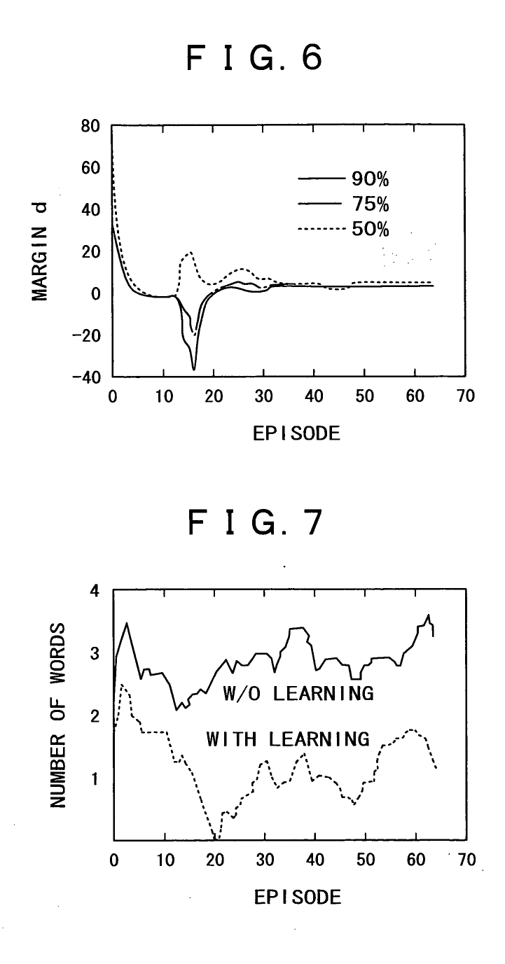

An experiment of the overall confidence level function f is explained as follows. An initial shape of the overall confidence level function f is set to represent a state requiring a large margin d allowing the conversational partner to understand an utterance given by the robot, that is, a state in which the overall confidence level of a mutual faith is low. The expected correct understanding rate ξ to be used in generation of an utterance is set at a fixed value of 0.75. Even if the expected correct understanding rate ξ is fixed, however, the output of the overall confidence level function f actually used disperses in the neighborhood of the expected correct understanding rate ξ and, in addition, an utterance may not be given correctly in some cases. Thus, the overall confidence level function f can be well inferred in a relatively wide range in the neighborhood of the inverse overall confidence level function f⁻¹(ξ) Changes of the overall confidence level function f and changes of the number of words used for describing all objects involved in actions are shown in FIGS. 6 and 7 respectively. It is to be noted that FIG. 6 is a diagram showing changes of the overall confidence level function f in a learning process. On the other hand, FIG. 7 is a diagram showing changes of the number of words used for describing an object in each utterance.

In addition, in FIG. 6 shows three curves for f⁻¹(0.9), f⁻¹(0.75) and f⁻¹(0.5) so as to make changes of the shape of the overall confidence level function f easy to understand. As is obvious from FIG. 6, the output of the overall confidence level function f abruptly approaches 0 right after the start of the learning process so that the number of used words decreases. Thereafter, around in episode 15, the number of words decreases excessively, increasing the number of cases in which an utterance is not understood correctly. Thus, the gradient of the overall confidence level function f becomes small, exhibiting a phenomenon that the confidence level of the mutual faith-becomes low temporarily.

[Effects]

The following description considers meanings of a wrong action in an algorithm for creating a word-usage faith and correction of the wrong action. During a learning process to understand utterances given by the robot, in a first episode, a wrong operation is performed and, in a second episode, a correct action is carried out. In this case, parameters of the mutual faith are relatively much corrected. In addition, in a learning process wherein the robot gives an utterance, results of an experiment fixing the expected correct understanding rate ξ at 0.75 are shown. In an experiment fixing the expected correct understanding rate ξ at 0.95, however, the overall confidence level function f cannot be properly inferred due to the fact that almost all utterances are understood.

In both the algorithm for understanding utterances and the algorithm for giving utterances, it is obvious that the fact that an utterance is sometimes mistakenly understood promotes creation of the mutual faith. In order to create the mutual faith, correct propagation of the meaning of an utterance alone is not adequate. That is to say, a risk of misunderstanding the meaning of the utterance must accompany the propagation. By allowing the robot and the conversational partner to share such a risk, it is possible to support a function to transmit and receive information on the mutual faith through utterances at the same time.

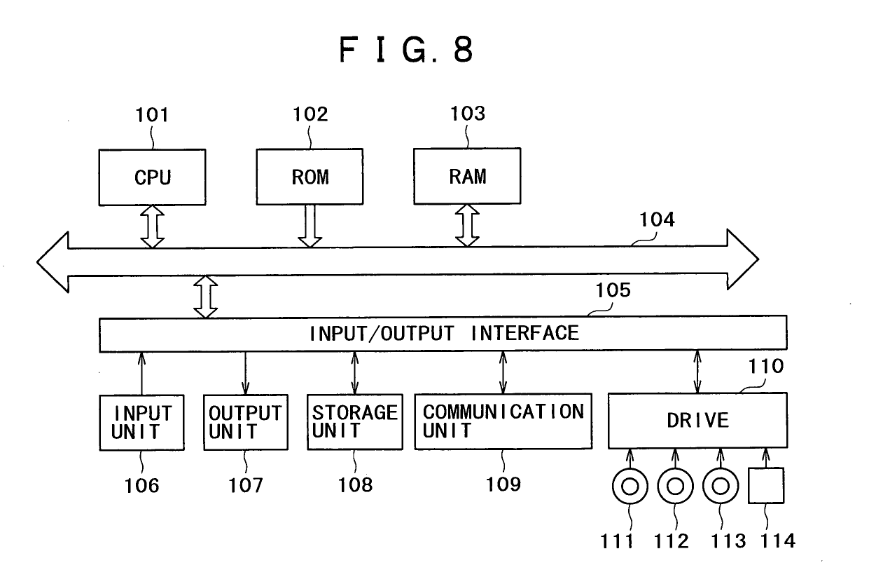

The series of processes described above can be carried out by hardware or software. In this case, the information-processing apparatus is implemented as a personal computer like one shown in FIG. 8.

In the personal computer shown in FIG. 8, a CPU (Central Processing Unit) 101 carries out various kinds of processing by execution of programs stored in a ROM (Read Only Memory) 102 or programs loaded in a RAM (Random Access Memory) 103 from a storage unit 108. The RAM 103 is also used for properly storing data required by the CPU 101 in the execution of the various kinds of processing.

The CPU 101, the ROM 102 and the RAM 103 are connected to each other by a bus 104. This bus 104 is also connected to an input/output interface 105.

The input/output interface 105 is connected to an input unit 106, an output unit 107, the storage unit 108 and a communication unit 109. The input unit 106 includes a keyboard and a mouse whereas the output unit 107 includes a display unit and a speaker. The display unit can be a CRT (Cathode Ray Tube) display unit or an LCD (Liquid Crystal Display) unit. The storage unit 108 typically includes a hard disk. The communication unit 109 includes a modem and a terminal adaptor. The communication unit 109 carries out communications with other apparatus by way of a network including the Internet.

If necessary, the input/output interface 105 is also connected to a drive 110, on which a magnetic disk 111, an optical disk 112, a magnetic-optical disk 113 or a semiconductor memory 114 is properly mounted to be driven by the drive 110. A computer program stored in the magnetic disk 111, the optical disk 112, the magnetic-optical disk 113 or the semiconductor memory 114 is installed into the storage unit 108 when necessary.

If the series of processes is to be carried out by using software, a variety of programs composing the software is installed typically from a network or a recording medium into a computer including embedded special-purpose hardware. Such programs can also be installed into a general-purpose personal computer capable of carrying out a variety of functions by execution of the installed programs.

The recording medium from which programs are to be installed into a computer or a personal computer is distributed to the user separately from the main unit of the information-processing apparatus. As shown in FIG. 8, the recording medium can be a package medium including programs, such as the magnetic disk 111 including a floppy disk, the optical disk 112 including a CD-ROM (Compact Disk Read-Only Memory) and a DVD (Digital Versatile Disk), the magnetic-optical disk 113 including an MD (Mini Disk) or the semiconductor memory 114. Instead of using such a package medium, the programs can also be distributed to the user by storing the programs in advance typically in the ROM 102 and/or a hard disk included in the storage unit 108, which are embedded beforehand in the main unit of the information-processing apparatus.

In this specification, steps prescribing a program stored in a recording medium can of course be executed sequentially along the time axis in a predetermined order. It is to be noted that, however, the steps do not have to be executed sequentially along the time axis in a predetermined order. Instead, the steps may include pieces of processing to be carried out concurrently or individually.

In addition, a system in this specification means the entire system including a plurality of apparatus.

The present invention is not limited to the details of the above described preferred embodiments. The scope of the invention is defined by the appended claims and all changes and modifications as fall within the equivalence of the scope of the claims are therefore to be embraced by the invention.

1. An information-processing apparatus for giving an utterance to a conversational partner to cause the conversational partner to understand an intended meaning of the utterance, the information-processing apparatus comprising:
function inference means for inferring an overall confidence level function representing a probability that the conversational partner understands the utterance by using a learning process; and
utterance generation means for generating the utterance by estimating a probability that the conversational partner understands the utterance based on the overall confidence level function produced by the function inference means.

2. The information-processing apparatus according to claim 1 wherein the utterance generation means further generates the utterance also based on a determination function for inputting the utterance and an understandable meaning of the utterance and for representing a degree of propriety between the utterance and the understandable meaning of said utterance.

3. The information-processing apparatus according to claim 2 wherein the overall confidence level function inputting inputs a difference between a maximum value of an output generated by the determination function as a result of inputting the utterance used as a candidate to be generated as well as the intended meaning of said utterance and a maximum value of an output generated by the determination function as a result of inputting the utterance used as a candidate to be generated as well as a meaning other than the intended meaning of the utterance.

4. An information-processing method for giving an utterance to a conversational partner to make the conversational partner understand an intended meaning of the utterance, the information-processing method comprising the steps of:
inferring an overall confidence level function representing a probability that the conversational partner understands the utterance by using a learning process; and
generating the utterance by estimating a probability that the conversational partner understands the utterance based on the overall confidence level function obtained the step of inferring.

5. An information-processing program to be executed by a computer to provide an utterance to a conversational partner to cause the conversational partner to understand an intended meaning of the utterance, said information-processing program comprising the steps of:
inferring an overall confidence level function representing a probability that the conversational partner understands the utterance by using a learning process; and
providing the utterance by estimating a probability that the conversational partner understands the utterance based on the overall confidence level function obtained in the step of inferring.
